(19) United States
(12) Patent Application Publication
(10) Pub. No.: US 2005/0071510 A1
(43) Pub. Date: Mar. 31, 2005

(54) Transport layer communication

(75) Inventor: Petros Belimpasakis, Thessaloniki (GR)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/675,913

(22) Filed: Sep. 29, 2003

(51) Int. Cl. G06F 15/16

(52) U.S. Cl. 709/250; 709/206; 709/230

(57) ABSTRACT

The invention relates to a method for a communication device which comprises a first software application and which communicates with a network by using a layered protocol stack comprising a transport layer. The method comprises providing a second software application at the same communication device, wherein the second software application implements a transport layer proxy between the first software application and the network.

### FIELD OF THE INVENTION

The invention relates to communication between a communication device and a network by using a layered protocol stack comprising a transport layer.

### BACKGROUND OF THE INVENTION

Terminal devices, such as smart phones have built-in features that are sometimes difficult to extend. The devices have a plurality of network interfaces (or access points), such as GPRS (General Packet Radio Service), CSD (Circuit Switched Data), HSCSD (High-Speed CSD), Infrared, Bluetooth, WLAN (Wireless Local Area Network) through which they can establish connections with remote servers.

Especially now that small wireless ad-hoc and Personal Area Networks (PAN) spread around, in certain geographical locations there may be multiple connectivity methods available for establishing connections to remote servers. For example, in a situation shown in FIG. 1, a remote server 150 is connected to the Internet 140. A connection from a terminal device 100, over an air-interface, to the remote server 150 may be established using a bearer (GPRS, CSD (data call)) provided by a GSM network 131 or using a bearer provided by a Bluetooth network 132.

When there are multiple transport bearer alternatives for crossing the air-interface between the terminal device and the network, the user of the terminal may manually make the selection of which bearer (or interface, or access point) to use for a transport layer connection, such as a TCP connection.

FIG. 2 shows an arrangement according to a prior art e-mail service. This service provides a user 99 of the terminal 100 with an e-mail account. The user can check his/her e-mail messages relating to this e-mail account at the e-mail server 150 via a TCP connection. The TCP connection is established between a built-in e-mail client application 105 and the server 150 via the network or combination of networks 120.

With terminal devices 100, such as Nokia Symbian OS (Operating System) based mobile phones, the user 99 can specify access points for establishing network connections (here: a TCP connection). The user may have different “access point profiles”. The user can instruct (or select) the phone to use, for example, access point A (e.g., GPRS bearer), access point B (e.g., CSD bearer) or another predefined access point (here: access point X (e.g., HSCSD bearer)) when checking his/her personal e-mail with the built-in e-mail client 105 with the aid of the TCP connection. The selected access point (or bearer) is going to be used every time when the user connects to this e-mail account.

If the access point A is selected, settings of the e-mail client 105 would typically comprise the fact that the access point A is being used, an SMTP (Simple Mail Transfer Protocol) server address of the e-mail server 150 (here: mail.isp.com) and a POP/IMAP (Post Office Protocol/Internet Message Access Protocol) server address of the e-mail server 150 (here: mail.isp.com), as indicated in the uppermost settings box in FIG. 2 (correspondingly for access points B and X). Knowing the server address and the access point to be used the e-mail client 105 may contact the server 150.

In some cases it may be desirable to use another access point than earlier for checking e-mail messages. This could be the case if, for example, the user's network operator offers the use of another access point with a cheaper price for a certain period of time. For example, the operator might offer data calls (access point B) for a price lower than that of a GPRS bearer connection during night time. A switch from using access point A to using access point B would require the user 99 to change the settings of the e-mail client 105. Typically, the user should go to a suitable menu of the device 100, choose the e-mail client application settings, choose the tab for access points, select the access point B and save these settings. In order to always have an optimal access point in use the user 99 should, basically, check the settings of the e-mail client 105 every time before connecting to the e-mail server 150.

Which access point is optimal may depend on time or other parameters, such as location or service availability. For example, connectivity to a GPRS system might be available but also connectivity to a Bluetooth might exist in a certain location, and there might be a substantial difference in a service price.

Naturally, the procedure of checking and changing settings of the e-mail client 105 is time consuming and may be rather complicated.

Previously, the problem relating to bearer selection has been solved by modifying the e-mail client application to make bearer selection decisions, or by using software that modifies parts of the operating system or uses special operation system APIs (Application Programming Interface). The previous solutions apply in cases where the vendor of the device allows such modifications and provides such APIs. However, there are cases where developers might not have the rights to do such modifications, or those would require a lot of work. For example, a set-top-box may have a fixed e-mail client which can not be modified, and its operating system might not allow the required changes to be made.

Another problem that one can face when dealing with transport bearer selection and/or extension of functionalities of network-based applications is support for new network interfaces. In the example presented in the preceding with the aid of FIG. 2, the terminal device has options of using either GRPS, CSD or HSCSD bearers for establishing a network connection. If a new network interface (or bearer) is added to the terminal, this would require appropriate changes in existing applications and/or the operating system of the terminal. For example, a Bluetooth or WLAN interface may be added so that the user can connect to the Internet, with the terminal, using Bluetooth or WLAN radio bearer via a compatible access point (and not through the GSM network). However, modification of at least some of the operating system parameters is required in order to get the new interface into operation. Accordingly, one can see the need for providing support for a new bearer without changing existing applications and/or the operating system (or with only a minimum amount of changes).

Yet another problem, which is presently rather common in certain terminal devices, is that they lack support for multiple users. An example would be a set-top-box that has an e-mail client application but does not support different user profiles. This means that an e-mail account can be specified for one user only. If different users want to use the same device, they have to use their own e-mail account settings. Accordingly, every time a different user uses the e-mail client application, certain settings (i.e., e-mail parameters) have to be changed. This is, again, time consuming and may be rather complicated.

### SUMMARY OF THE INVENTION

With the aid of the present invention one or more of the problems known from the prior art can be solved or, at least, the effect of these problems can be mitigated.

According to a first aspect of the invention, there is provided a method for a communication device which communication device comprises a first software application and which communication device communicates with a network by using a layered protocol stack comprising a transport layer, the method comprising:

providing a second software application at the same communication device, wherein the second software application implements a transport layer proxy between the first software application and the network.

An example of the transport layer is the TCP (Transmission Control Protocol) layer. The communication device may be a wireless device or a device functioning in a wired environment.

In an embodiment of the invention, an open, application level, middleware component is used for adding functionalities to existing applications of terminal devices, such as an e-mail client, web browser, etc.. An embodiment provides a way of extending the functionalities of network-based applications without any changes to the operating system of the device or to the existing applications. In an embodiment, said component is a special add-on application. Said special application is installed in a terminal device and it acts as a TCP server for one or more other end-user applications running on the same device. In parallel, this server acts as a TCP client to a remote server (for example an e-mail server or another server), located in the network, while changing some of the communication parameters.

Embodiments of the invention help to overcome product specific limitations. In an embodiment, a middleware application makes, without user interaction, an automatic decision on the most appropriate bearer for crossing an air-interface. In an embodiment, the addition of a new transport bearer is enabled. In another embodiment, a device, which originally does not support multiple users, is enabled with multiple user support.

According to a second aspect of the invention, there is provided a communication device which comprises a first software application and which communication device is configured for communication with a network by using a layered protocol stack comprising a transport layer, the communication device further comprising:

a second software application at the same communication device, wherein the second software application is configured to implement a transport layer proxy between the first software application and the network.

According to a third aspect of the invention, there is provided a system comprising a communication device and a network, which communication device comprises a first software application and which communication device is configured for communication with the network by using a layered protocol stack comprising a transport layer, the communication device further comprising:

a second software application at the same communication device, wherein the second software application is configured to implement a transport layer proxy between the first software application and the network.

According to a fourth aspect of the invention, there is provided a software application executable in a communication device, which communication device comprises another software application and which communication device is configured for communication with a network by using a layered protocol stack comprising a transport layer, the software application comprising: program code for implementing a transport layer proxy between said another software application and the network.

The software application may be a computer program product, comprising program code, stored on a medium, such as a memory.

Dependent claims relate to embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows a multi-bearer communications system;

FIG. 2 shows an arrangement according to a prior art e-mail service;

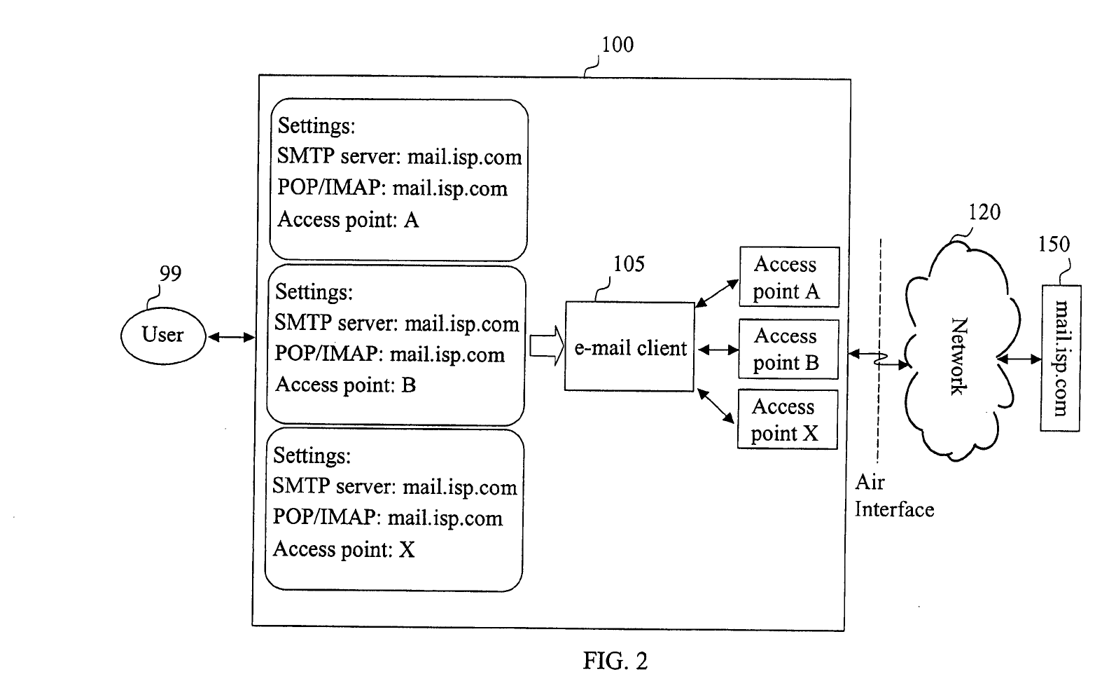

FIG. 3 shows an arrangement according to an embodiment of the invention;

FIG. 4 shows a terminal device according to an embodiment of the invention; and

FIG. 5 shows an arrangement according to another embodiment of the invention.

### DETAILED DESCRIPTION

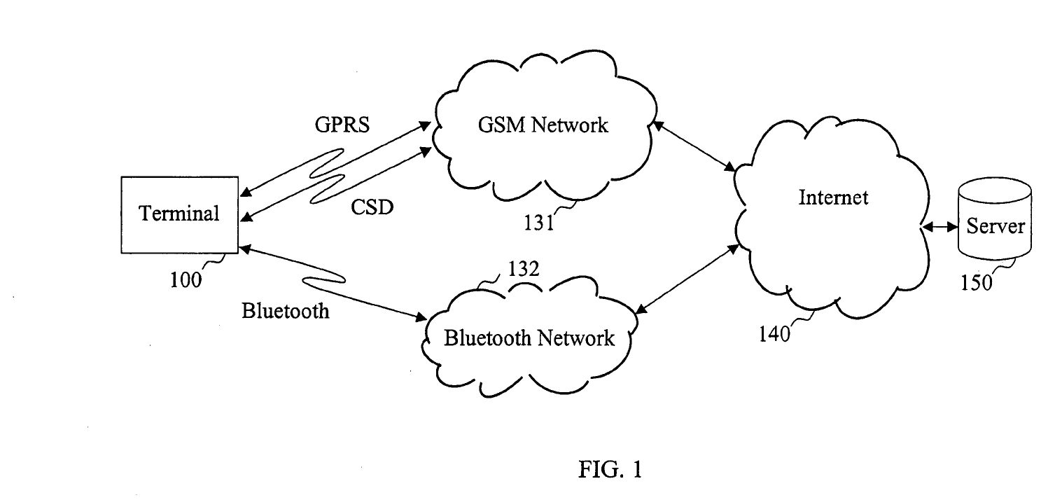

FIG. 1 has been described in the preceding in the prior art section of this description. However, a reference to FIG. 1 is made also here, since the network infrastructure presented in FIG. 1 is applicable to embodiments of the invention.

In embodiments of the invention an open, application level, middleware component is used for extending functionalities of existing network-based software applications in terminal devices. In the following, TCP is used as an example of a transport layer protocol (as to the definition of a transport layer, a reference is made to the OSI model (Open Systems Interconnection) presented by ISO (International Organization of Standards)). However, a skilled person will recognize that embodiments of the invention should not be restricted to TCP only, but they are also applicable to other suitable transport layer protocols.

In an embodiment, the mentioned component is a special add-on application which, for example, may be named “Local Traffic Controller” or “Local TCP Traffic Controller” (LTTC, reference number 115). This application comprises program code and is installed (or downloaded and installed with suitable settings) in a terminal device and it acts as a TCP server for one or more other applications (end-user applications) running on the same terminal device. In parallel, the special application acts as a TCP client to another TCP server outside the device, thus enabling a TCP connection to the outside of the device.

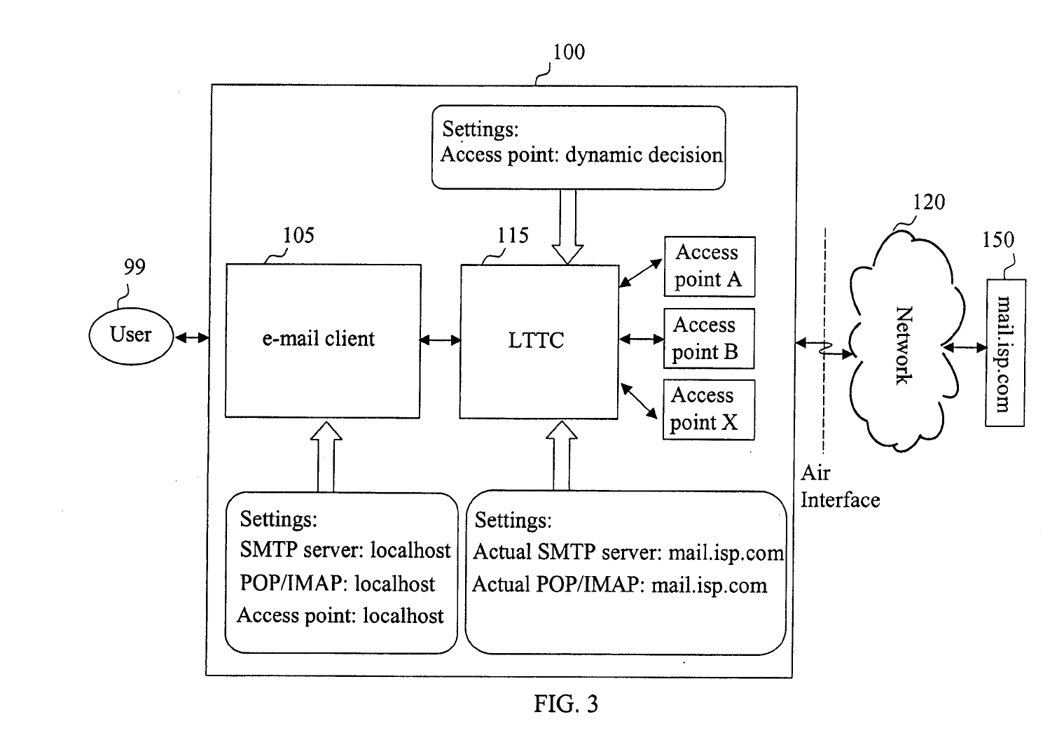

FIG. 3 shows an exemplary embodiment. In this embodiment, an e-mail client 105 of a terminal device 100 (here: mobile phone) requires a POP/SMTP mail server 150 and an access point to be defined. Instead of providing the real server address (here: mail.isp.com), the address of the LTTC is provided (the address is a local address, it may be simply defined to be localhost, for example). As far as the access point is concerned, any particular access point is not provided but the access point is just defined to be localhost. All these setting have been predefined in the terminal device 100, therefore the user 99 does not need to specify any settings before connecting to the e-mail server 150.

A TCP connection to the server 150 is established in the following way: The e-mail client 105 makes a (local) TCP connection to the LTTC. The LTTC accepts the TCP connection and at the same time opens another TCP connection to the actual e-mail server 150 via the network or combination of networks 120. The LTTC has the connection details (among other things, the address mail.isp.com) of the actual e-mail server 150. What is only missing is the interface (access point) through which the TCP connection to the actual e-mail server 150 is to be established. This decision will be taken by the LTTC. It makes a dynamic decision of which access point to use. The LTTC can, for example, use a rule engine to choose automatically the most optimal access point in each situation. In the choosing-process, rules predefined by the user and/or the current time and/or location information and/or network availability and/or other suitable parameters may be taken into account. When (after the decision on the access point has been made) the TCP connection has been established, the LTTC forwards the traffic between the other two parties (the e-mail client 105 and the server 150) without them knowing of its existence. Traffic from the e-mail client 105 is forwarded to this new connection to the server 150 and vice versa. The LTTC makes appropriate modifications to the control data section of packets to be forwarded so that they are delivered to the right destination. If needed, it may also modify the actual payload data.

Because the e-mail client 105 and the LTTC are two different entities, the functionality of the e-mail client 105 can be extended with the aid of the LTTC without any modification to the e-mail client 105. In the embodiment just described, the functionality is extended with a bearer selection mechanism. As described, the LTTC (middleware application) makes the decision on which access point to use on behalf of the e-mail client. The user does not have to change any e-mail client settings before connecting to the server 150. The decision-making operation is transparent to the e-mail client (i.e., no modification of the e-mail client application is needed) and also to the operating system (no modification of the operating system is needed either). In this embodiment, the LTTC acts in the way a router acts in an Ethernet network, but in a local level, while combining functionalities of a network proxy.

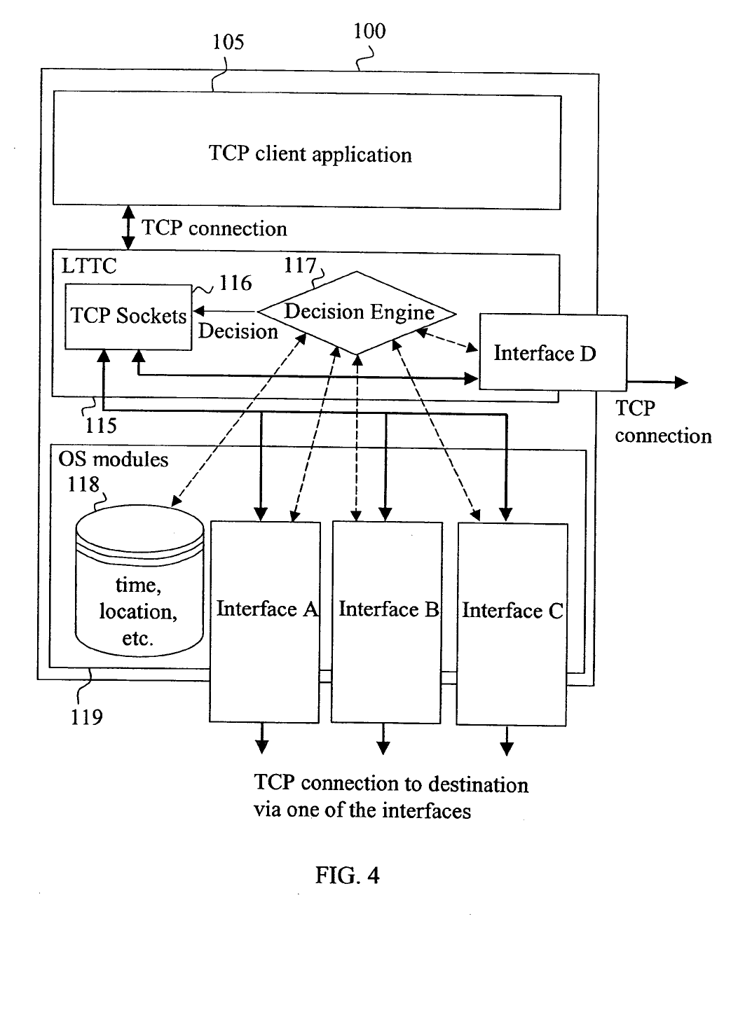

FIG. 4 shows a device according to an embodiment of the invention. The device 100 comprises a TCP client application 105 (e.g. the e-mail client or a web browser), the LTTC and operating system provided modules 119. The LTTC comprises TCP sockets 116 and a decision engine 117. The operating system provided modules 119 comprise network interfaces (access points) A (e.g. GPRS radio bearer), B (e.g. CSD radio bearer) and C (e.g. HSCSD radio bearer), and a database 118 for providing the decision engine 117 with information (time, location, availability of different networks, etc.) for its decision process. When a TCP connection to a remote server (not shown in FIG. 4) is needed the TCP client application 105 makes a (local) TCP connection to the LTTC. The TCP sockets 116 accept the TCP connection and at the same time open another TCP connection to the desired server. The rule engine 117 makes a dynamic decision of which network interface (access point A, B or C) to use based on information provided by the database 118. When (after the decision on the access point has been made) the TCP connection has been established, the LTTC forwards the traffic between the other two parties (the e-mail client 105 and the server 150). In this respect the operation of the embodiment of FIG. 4 does not substantially differ from the operation of the embodiment of FIG. 3.

However, FIG. 4 also shows a special case, which enables support for a new bearer service (e.g. Bluetooth) for crossing an air-interface. The support is provided for by the LTTC, which is installed between the TCP client application 105 and the hardware network interface concerned (here: interface D). The decision engine 117 can now choose the interface (or access point) to be used in the TCP connection to the desired server among the interfaces A, B, C and D. Thus, the TCP client application 105 can now have access to the desired server, instead of using the operating system provided interfaces A, B or C, through the new interface D, via the LTTC. In this way, the LTTC proxy 115 can provide a new interface not natively supported by the operating system with no need for modifications to the operating system or to the TCP client application 105.

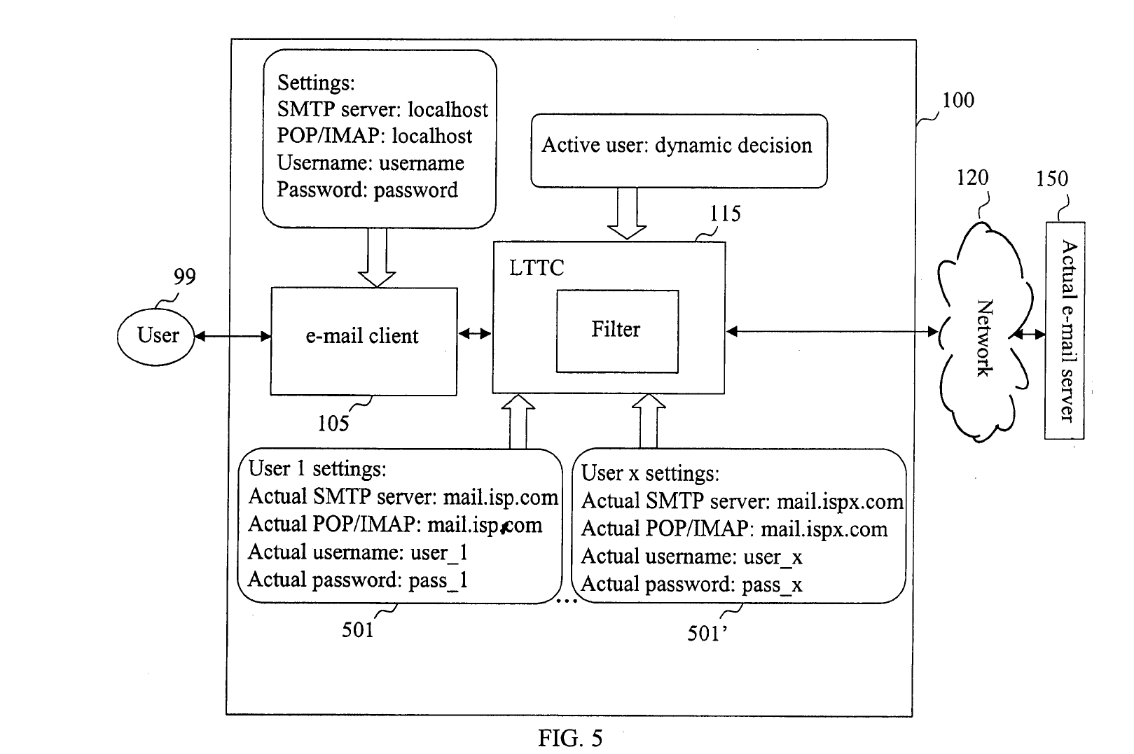

FIG. 5 shows an arrangement according to another embodiment of the invention. With this embodiment it is possible to extend the functionalities of a terminal device 100 (e.g., set-top-box) having an e-mail application but lacking multiple user support with support for multiple users.

FIG. 5 shows the terminal device 100 comprising an e-mail client 105 and a middleware application, i.e. the LTTC proxy 115. The settings of the LTTC have been predefined in the device. These comprise a plurality of user e-mail profiles (user settings 501 . . . 501′) for different users (users 1 . . . X). In these profiles, the users have their own usernames, passwords and e-mail server addresses for the e-mail service.

Also the e-mail client settings have been predefined. These comprise generic server address(es) to be used (here: localhost) and a generic username and password in common for all users. Access point settings are not particularly discussed in this embodiment. However, it is possible to use an arrangement similar to those of the previous embodiments.

When access to the actual e-mail server 150 is needed, the e-mail client opens a TCP connection to the LTTC. The LTTC makes a dynamic decision on which user is using the device 100. The LTTC can, for example, determine the identity of the user with the aid of a pop-up login window in which the user is asked to input his/her username and password. After identifying the user the LTTC establishes a TCP connection to the desired e-mail server 150. The connection may be implemented via a wired or wireless network. The communication traffic between the e-mail client 105 and the e-mail server 150 is filtered by a LTTC filter which replaces the generic username and password with the real ones (according to the logged user), as well as the generic e-mail server address (here: localhost) with the real server address (e.g., mail.isp.com (concerning user 1)).

Because of the LTTC, the embodiment just described enables having an unlimited number of users on the same device, even though the built-in e-mail application does not natively support that. Each user which has a profile in the LTTC can use the same e-mail client, with no need to modify the existing applications.

Embodiments of the invention have been presented which provide an add-on application for terminal devices. An automatic network interface selection is enabled. Also, the presented embodiments enable multiple user support and support for addition of a new bearer without a need to modify the existing application or the operating system.

Yet another embodiment of the invention is suitable for the situation in which the remote server to which a connection is desired uses a dynamic address. In that case, the address of the server may suddenly change and clients (e.g. e-mail clients) connecting to this server would need to be reconfigured. By having the middleware application functioning as a proxy between the client and the server, the middleware application would replace the old server address with a new one (after being notified by the server of the new address). No settings of the client would have to be modified because the client would still have the generic address (here: localhost) as the server address.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for a communication device
which communication device comprises a first software application and which communication device communicates with a network by using a layered protocol stack comprising a transport layer, the method comprising:
providing a second software application at the same communication device, wherein the second software application implements a transport layer proxy between the first software application and the network.

2. The method of claim 1, wherein the communication device communicates with the network via an air interface.

3. The method of claim 1, wherein the method comprises accessing a remote server by establishing:
(i) a local transport layer connection between the first software application and the second software application, and
(ii) a further transport layer connection between the second software application and the remote server.

4. The method of claim 3, wherein the local transport layer connection and the further transport layer connection are client-server based connections.

5. The method of claim 1, wherein the second software application acts as a proxy for the first software application and provides at least one additional service for the first software application or for the user of the device.

6. The method of claim 5, wherein the provided additional service comprises selecting a network interface to be used in the case where more than one network interface is available.

7. The method of claim 5, wherein the provided additional service comprises selecting a bearer for crossing an air interface.

8. The method of claim 7, wherein the bearer operates in the protocol stack on a layer lower than the transport layer.

9. The method of claim 6, wherein the selection of a network interface or a bearer is performed based on information which comprises at least one of the following: network availability, user-defined rules, time, location, cost.

10. The method of claim 5, wherein the provided additional service comprises providing a network interface not natively supported by an operating system of the device.

11. The method of claim 5, wherein the provided additional service comprises providing support for multiple users.

12. The method of claim 11, wherein support for multiple users is implemented via a set of predefined user profiles.

13. The method of claim 5, wherein the provided additional service comprises receiving information indicative of a change in a remote server address and modifying the remote server address at the communication device by the second software application, whereby no modification in the first software application is needed.

14. The method of claim 1, wherein the first software application is an e-mail client, web browser or another end-user application.

15. The method of claim 1, wherein the transport layer is implemented by TCP (Transmission Control Protocol).

16. A communication device which comprises a first software application and which communication device is configured for communication with a network by using a layered protocol stack comprising a transport layer, the communication device further comprising:
a second software application at the same communication device, wherein the second software application is configured to implement a transport layer proxy between the first software application and the network.

17. The communication device of claim 16, wherein the communication device is configured for communication via an air interface.

18. The communication device of claim 16, wherein the communication device is configured for access to a remote server by establishing:
(iii) a local transport layer connection between the first software application and the second software application, and
(iv) a further transport layer connection between the second software application and the remote server.

19. The communication device of claim 18, wherein the local transport layer connection and the further transport layer connection are client-server based connections.

20. The communication device of claim 16, wherein the second software application comprises program code for acting as a proxy for the first software application and for providing at least one additional service for the first software application or for the user of the device.

21. The communication device of claim 20, wherein the provided additional service comprises selecting a network interface to be used in the case where more than one network interface is available.

22. The communication device of claim 20, wherein the provided additional service comprises selecting a bearer for crossing an air interface.

23. The communication device of claim 22, wherein the bearer is operable in the protocol stack on a layer lower than the transport layer.

24. The communication device of claim 22, wherein the second software application comprises program code for selecting the network interface or the bearer based on information which comprises at least one of the following:
network availability, user-defined rules, time, location, cost.

25. The communication device of claim 20, wherein the provided additional service comprises providing a network interface not natively supported by an operating system of the device.

26. The communication device of claim 20, wherein the provided additional service comprises providing support for multiple users.

27. The communication device of claim 26, which is configured provide support for multiple users via a set of predefined user profiles.

28. The communication device of claim 20, wherein the provided additional service comprises receiving information indicative of a change in a remote server address and modifying the remote server address at the communication device by the second software application, whereby no modification in the first software application is needed.

29. The communication device of claim 16, wherein the first software application is an e-mail client, web browser or another end-user application.

30. The communication device of claim 16, wherein the transport layer is a TCP (Transmission Control Protocol) layer.

31. A system comprising a communication device and a network, which communication device comprises a first software application and which communication device is configured for communication with the network by using a layered protocol stack comprising a transport layer, the communication device further comprising:
a second software application at the same communication device, wherein the second software application is configured to implement a transport layer proxy between the first software application and the network.

32. The system of claim 18, wherein the communication device is configured for communication with the network via an air interface.

33. A software application executable in a communication device, which communication device comprises another software application and which communication device is configured for communication with a network by using a layered protocol stack comprising a transport layer, the software application comprising:
program code for implementing a transport layer proxy between said another software application and the network.

34. The software application of claim 33, wherein the software application is a computer program product stored on a medium.
